(19) United States
(12) Patent Application Publication
(10) Pub. No.: US 2012/0186877 A1
(43) Pub. Date: Jul. 26, 2012

(54) Modified Cellulosic Polymer for Improved Well Bore Fluids

(76) Inventor: Ryan G. Ezell, Summit, MS (US)

(21) Appl. No.: 13/193,897

(22) Filed: Jul. 29, 2011

Related U.S. Application Data
(60) Provisional application No. 61/373,673, filed on Aug. 13, 2010.

(51) Int. Cl. E21B 7/00; C09K 8/00; C09K 8/10

(52) U.S. Cl. 175/57; 507/114; 507/216

(57) ABSTRACT

In one embodiment, the invention provides a method comprising: providing a drilling fluid, completion fluid, or workover fluid comprising an aqueous base fluid and a nonionic cellulose ether polymer having hydroxyethyl groups and being further substituted with one or more hydrophobic substituents, and placing the drilling fluid, completion fluid, or workover fluid in a subterranean formation.

### CROSS REFERENCE TO RELATED APPLICATION

The present application claims priority to U.S. Provisional Patent Application Ser. No. 61/373,673 filed on Aug. 13, 2010, the entire disclosure of which is incorporated herein by reference.

### BACKGROUND

The present invention relates to methods for treating subterranean formations. More particularly, in certain embodiments, the present invention relates to drilling, completion, or workover fluids that comprise nonionic cellulose ether polymers and their use in subterranean applications.

Many subterranean treatments require viscosified fluids. For instance, viscosified fluids are used in drilling fluids, completion fluids, workover fluids, as well as other treating fluids. The term “drilling fluid” as used herein refers to any of a number of liquid and gaseous fluids and mixtures of fluids and solids (as solid suspensions, mixtures and emulsions of liquids, gases and solids) used in operations to drill boreholes into the earth. The term drilling fluid includes “drill-in fluids,” The term “completion fluid” as used herein refers to a fluid with a low solids content that may be used to “complete” an oil or gas well, for example, to facilitate final operations prior to initiation of production, such as setting screens production liners, packers, downhole valves or shooting perforations into the producing zone. In some embodiments, a completion fluid may be used to control a well should downhole hardware fail, without damaging the producing formation or completion components. The term “workover fluid” as used herein refers to well-control fluids, for example a brine, that is used during workover operations.

Polymeric viscosifying agents, such as cellulose derivatives, guar gums, biopolymers, polysaccharides, synthetic polymers, and the like, have previously been added to treatment fluids to obtain a desired viscosity. Viscoelastic surfactants have also been added to treatment fluids to increase the viscosity thereof. Maintaining sufficient viscosity in these treatment fluids may be important for a number of reasons. For example, maintaining sufficient viscosity is important in drilling operations, for example, to provide hydrostatic pressure to prevent formation fluids from entering into the well bore, keep the drill bit cool and clean during drilling, carry out drill cuttings, and suspend the drill cuttings while drilling is paused and when the drilling assembly is brought in and out of the hole. Also, maintaining sufficient viscosity may be important to control and/or reduce fluid loss into the formation. Moreover, a treatment fluid of a sufficient viscosity may be used to divert the flow of fluids present within a subterranean formation (e.g., formation fluids, other treatment fluids) to other portions of the formation, for example, by “plugging” an open space within the formation. At the same time, while maintaining sufficient viscosity of the treatment fluid often is desirable, it also may be desirable to maintain the viscosity of the treatment fluid in such a way that the viscosity may be reduced at a particular time, inter alia, for subsequent recovery of the fluid from the formation.

Commonly used cellulose-based viscosifying agents are generally not believed to be thermally stable and easily solubilized. Biopolymers are frequently used instead of cellulose in treatment fluids due to their favorable water solubility and thermal stability, however, use of such biopolymers can be problematic because they leave residue behind. After completing a treatment, remedial treatments may be required to remove the residue so that the wells may be placed into production. For example, a chemical breaker, such as an acid, oxidizer, or enzyme may be used to either dissolve the solids or reduce the viscosity of the treatment fluids. In many instances, however, use of a chemical breaker to remove the residue from inside the well bore and/or the formation matrix may be ineffective due to the properties of such biopolymers. Furthermore, excessive use of chemical breakers to degrade such polymers may be corrosive to downhole tools and may leak off into the formation, carrying undissolved fines that may plug and/or damage the formation or may produce undesirable reactions with the formation.

### SUMMARY

The present invention relates to methods for treating subterranean formations. More particularly, in certain embodiments, the present invention relates to drilling, completion, or workover fluids that comprise nonionic cellulose ether polymers and their use in subterranean applications.

In one embodiment the present invention provides a method comprising: providing a drilling fluid, completion fluid, or workover fluid comprising an aqueous base fluid and a nonionic cellulose ether polymer having hydroxyethyl groups and being further substituted with one or more hydrophobic substituents, wherein the cellulose ether has at least one of the following properties (a), (b) or (c):

(a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution;

(b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution;

(c) a critical association concentration of less than 15 ppm as measured by light-scattering, and

placing the drilling fluid, completion fluid, or workover fluid in a subterranean formation.

In another embodiment the present invention provides a method comprising: providing a drilling fluid comprising an aqueous base fluid and a nonionic cellulose ether polymer having hydroxyethyl groups and being further substituted with one or more hydrophobic substituents, wherein the cellulose ether has at least one of the following properties (a), (b) or (c):

(a) a retained dynamic viscosity, % η_{80/25}, of at least 30 percent, wherein

% η_{80/25}=[dynamic solution viscosity at 80° C./dynamic solution viscosity at 25° C.]×100, the dynamic solution viscosity at 25° C. and 80° C. being measured as 1% aqueous solution;

(b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution;

(c) a critical association concentration of less than 15 ppm as measured by light-scattering; and drilling a well bore in a formation in an operation comprising the drilling fluid.

The features and advantages of the present invention will be readily apparent to those skilled in the art upon a reading of the description of the embodiments that follows.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a graphical representation of the rheological performance of a fluid containing nonionic cellulose ether polymer in various brines,

FIGS. 2A-B are graphical representations of the rheological performance of a fluid containing nonionic cellulose ether polymer versus various other viscosifying agents in 10 ppg of NaBr.

FIGS. 3A-B are graphical representations of the rheological performance of a fluid containing nonionic cellulose ether polymer versus various other viscosifying agents in 10 ppg of NaBr post hot-roll at 220° F.

FIGS. 4A-B are graphical representations of the rheological performance of a fluid containing nonionic cellulose ether polymer versus various other viscosifying agents in 13.5 ppg of CaBr₂.

FIGS. 5A-B are graphical representations of the rheological performance of a fluid containing nonionic cellulose ether polymer versus various other viscosifying agents in 10 ppg of CaBr₂ post hot-roll at 220° F.,

FIGS. 6A-B are graphical representations of the rheological performance of a fluid containing nonionic cellulose ether polymer versus various other viscosifying agents in 15.5 ppg Ca/ZnBr₂.

FIGS. 7A-B show the temperature profiles for the nonionic cellulose ether polymer versus various other viscosifying agents.

FIGS. 8A-B are graphical representations of the rheological performance of a fluid containing nonionic cellulose ether polymer and a defoamer.

FIG. 9 depicts the dynamic rheological studies performed to evaluate the storage (G′) and loss (G″) moduli of nonionic cellulose ether polymer versus Xanthan and unmodified hydroxyethylcellulose.

FIG. 10 depicts an evaluation of thermal stability via temperature cycling to simulate drilling conditions for the nonionic cellulose ether polymer.

FIG. 11 is a graphical representation of the breakdown of nonionic cellulose ether polymer in the presence of heat and acid.

While the present invention is susceptible to various modifications and alternative forms, specific embodiments thereof have been shown by way of example in the figures and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention relates to methods for treating subterranean formations. More particularly, in certain embodiments, the present invention relates to drilling, completion, or workover fluids that comprise nonionic cellulose ether polymers and their use in subterranean applications.

In some embodiments, the nonionic cellulose ether polymers used in the drilling, completion, or workover fluids of the present invention provide better solubility of the polymer and have greater thermal stability as compared to other fluids, while maintaining the removal capabilities of traditional unmodified hydroxyethylcellulose in drilling, completion, or workover operations. The drilling, completion, or workover fluids may have greater gel strength during the operations, but require relatively quick removal of the gels. In certain embodiments, the nonionic cellulose ether polymers exhibit excellent suspension capabilities above conventional unmodified hydroxyethylcellulose.

Another potential advantage of the methods of the present invention is that they may allow use in subterranean formations where complete removal of gels is needed by acid degradation. Another potential advantage of the methods of the present invention is the increased suspension of the nonionic cellulose ether polymer in a drilling, completion, or workover fluid. The increased suspension of the nonionic cellulose ether polymer in a drilling, completion, or workover fluid may lead to better thermal stability that in turn, is believed to aid in clay inhibition, especially in drilling, completion, and workover operations. Drilling, completion, and workover fluids comprising a nonionic cellulose ether polymer described herein may have increased viscosity efficiency when compared to other commonly used polymeric viscosifying agents in such operations.

Embodiments of the drilling, completion, and workover fluids of the present invention may comprise an aqueous base fluid and a nonionic cellulose ether having hydroxyethyl groups and being further substituted with one or more hydrophobic substituents, wherein the cellulose ether has at least one of the following properties (a), (b) or (c): (a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution; (b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution; and (c) a critical association concentration of less than 15 ppm as measured by light-scattering.

The aqueous base fluid utilized in embodiments of the drilling, completion, and workover fluids may be fresh water, salt water (e.g., water containing one or more salts dissolved therein), brine (e.g., saturated salt water), seawater, and any combinations thereof. The brines may contain substantially any suitable salts, including, but not necessarily limited to, salts based on metals, such as, calcium, magnesium, sodium, potassium, cesium, zinc, aluminum, and lithium. Salts of calcium and zinc are preferred. The salts may contain substantially any anions, with preferred anions being less expensive anions including, but not necessarily limited to chlorides, bromides, formates, acetates, and nitrates. The choice of brine may increase the associative properties of the nonionic cellulose ether polymer in the drilling, completion, or workover fluid. A person of ordinary skill in the art, with the benefit of this disclosure, will recognize the type of brine and ion concentration needed in a particular application of the present invention depending on, among other factors, the other components of the drilling, completion, and workover fluids, the desired associative properties of such fluids, and the like. Generally, the aqueous base fluid may be from any source, provided that it does not contain an excess of compounds that may adversely affect other components in the drilling, completion, or workover fluid. The aqueous base fluid may be present in embodiments of the drilling, completion, or workover fluids in an amount in the range of about 20% to about 99% by weight of the drilling, completion, or workover fluid. In certain embodiments, the base fluid may be present in the drilling, completion, or workover fluids in an amount in the range of about 20% to about 80% by weight of the drilling, completion, or workover fluid.

The drilling, completion, or workover fluids generally comprise a nonionic cellulose ether having hydroxyethyl groups and being further substituted with one or more hydrophobic substituents, wherein the cellulose ether has at least one of the properties (a), (b) or (c): (a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution; (b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution; (c) a critical association concentration of less than 15 ppm as measured by light-scattering.

Suitable nonionic cellulose ethers are substituted with one or more hydrophobic substituents, preferably with acyclic or cyclic, saturated or unsaturated, branched or linear hydrocarbon groups, such as an alkyl, alkylaryl or arylalkyl group having at least 8 carbon atoms, generally from 8 to 32 carbon atoms, preferably from 10 to 30 carbon atoms, more preferably from 12 to 24 carbon atoms, and most preferably from 12 to 18 carbon atoms. As used herein the terms “arylalkyl group” and “alkylaryl group” mean groups containing both aromatic and aliphatic structures. The most preferred aliphatic hydrophobic substituent is the hexadecyl group, which is most preferably straight-chained. The hydrophobic substituent is non-ionic.

Suitable nonionic cellulose ethers preferably have a weight average molecular weight of at least 1,000,000, more preferably at least 1,300,000. Their weight average molecular weight is preferably up to 2,500,000, more preferably up to 2,000,000.

Suitable nonionic cellulose ethers preferably have a Brookfield viscosity of at least 5000 mPa-sec, more preferably at least 6000 mPa-sec, and even more preferably at least 9000 mPa-sec. The nonionic cellulose ethers preferably have a Brookfield viscosity of up to 20,000 mPa-sec, more preferably up to 18,000 mPa-sec, and most preferably up to 16,000 mPa-sec. The Brookfield viscosity is measured as 1% aqueous solution at 30 rpm, spindle #4 at 25.0° C. on a Brookfield viscometer. The Brookfield viscosity is dependent on the hydrophobe substitution, but is also an indication of the molecular weight of the nonionic cellulose ether.

Suitable nonionic cellulose ethers have at least one of the properties further described below:

(a) a retained dynamic viscosity, % η_{80/25}, of at least 30 percent, wherein

% η_{80/25}=[dynamic solution viscosity at 80° C./dynamic solution viscosity at 25° C.]×100, the dynamic solution viscosity at 25° C. and 80° C. being measured as 1% aqueous solution;

(b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution; and

(c) a critical association concentration of less than 15 ppm as measured by light-scattering.

In some embodiments, the nonionic cellulose ether has two of the properties (a), (b) and (c) in combination. Alternatively, the nonionic cellulose ether has all three properties (a), (b) and (c) in combination.

A description of suitable nonionic cellulose ether polymers is in U.S. Provisional Patent Application Ser. No. 61/373,436, which is hereby incorporated by reference.

The nonionic cellulose ether polymer should be added to the aqueous base fluid in an amount sufficient to form the desired drilling fluid, completion fluid, or workover fluid. In certain embodiments, the nonionic cellulose ether polymer may be present in an amount of about 0.01% to about 15% by weight of the drilling, completion, or workover fluid. In certain embodiments, the nonionic cellulose ether polymer may be present in an amount of about 0.1% to about 10% by weight of the drilling, completion, or workover fluid. A person of ordinary skill in the art, with the benefit of this disclosure, will recognize the amount of polymer or polymers to include in a particular application of the present invention depending on, among other factors, the other components of the drilling, completion, or workover fluids, the desired viscosity of the drilling, completion, or workover fluids, and the like.

Although not wishing to be limited by any particular theory, the nonionic cellulose ether polymers may have increased thermal stability when in the presence of brine versus water. In certain embodiments, the increase in thermal stability may be attributed to the minimization of the hydrolytic attack due to decreased free water in the drilling, completion, or workover fluid. In other embodiments, it is believed that the increase in thermal stability in aqueous base fluid may be due to changing the contact of the aqueous media with the backbone of the polymer chains, facilitating the protection of the acetal linkage (e.g., 1,4-glycocidic linkage) of the backbone. The acetal linkage is thought to be generally unprotected in unmodified hydroxyethylcellulose polymers.

Nonionic cellulose ether polymer may be used to increase the viscosity of drilling fluid, completion fluid, or workover fluid. The nonionic cellulose ether polymer may increase the viscosity of such fluids, for example, by associative interactions between hydrophobic groups of the nonionic cellulose ether polymer to form intermolecular micellar bonds, which result in a three-dimensional network. In certain embodiments, the nonionic cellulose ether polymers may result in a three-dimensional network able to maintain structure over a broader stress range, especially as compared to other biopolymers that have not been similarly modified. In an embodiment, the nonionic cellulose ether polymer is able to maintain structure in a stress range exceeding about 12 Pa.

Additional additives may be added to the drilling, completion, or workover fluids as deemed appropriate for a particular application by one skilled in the art, with the benefit of this disclosure. Examples of such additives include, but are not limited to, weighting agents, biocides, corrosion inhibitors, gel stabilizers, surfactants, scale inhibitors, antifoaming agents, foaming agents, fluid loss control additives, shale swelling inhibitors, radioactive tracers, defoamers, surfactants, crosslinking agents, particulates, pH-adjusting agents, pH buffers, salts, breakers, delinkers, weighting agents, corrosion inhibitors, combinations thereof, and the like, and numerous other additives suitable for use in subterranean operations.

In some embodiments, surfactants may be used to facilitate the formation of micellar bonds in a drilling fluid, completion fluid, or workover fluid. It is believed that the hydrophobic groups of the nonionic cellulose ether polymer may become incorporated into surfactant micelles, which are believed to act as crosslinkers for the polymer, creating structure and strength. These surfactants may show Newtonian or viscoelastic behavior when present in water by themselves in concentrations of less than 20%. In certain embodiments, the surfactant may be a non-viscoelastic surfactant. Suitable surfactants may be anionic, neutral, cationic or zwitterionic. Aqueous liquids containing the surfactants may respond to shear with a Newtonian or viscoelastic behavior. Anionic surfactants with Newtonian rheological behavior are preferred. Examples of suitable anionic surfactants include, but are not limited to, sodium decylsulfate, sodium lauryl sulfate, alpha olefin sulfonate, alkylether sulfates, alkyl phosphonates, alkane sulfonates, fatty acid salts, arylsulfonic acid salts, and combinations thereof. Examples of suitable cationic surfactants, include, but are not limited to, trimethylcocoammonium chloride, trimethyltallowammonium chloride, dimethyldicocoammonium chloride, bis(2-hydroxyethyl)tallow amine, bis(2-hydroxyethyl)erucylamine, bis(2-hydroxyethyl)coco-amine, cetylpyridinium chloride, and combinations thereof. Where used, the surfactant may be included in the drilling, completion, or workover fluid in an amount of about 0.1% to about 20% by weight of the drilling, completion, or workover fluid. One should note that if too much surfactant is used that the formation of micelles in the fluid may negatively impact the overall fluid.

In some embodiments, the nonionic cellulose ether polymer may be crosslinked by any suitable crosslinking agent or method. In some embodiments, a crosslinking agent may be utilized to crosslink the nonionic cellulose ether polymer to form the crosslinked viscosifying agent. In certain embodiments, the drilling, completion, or workover fluids may be formed by contacting an aqueous base fluid comprising nonionic cellulose ether polymers with a crosslinking agent, and allowing a crosslinked viscosifying agent to form.

A variety of crosslinking agents are suitable for use in the present invention. When used, the nonionic cellulose ether polymer will be referred to herein as being “crosslinked with a metal ion.” Examples of suitable crosslinking agents include, but are not limited to, borate releasing compounds and compounds that release transition metal ions when dissolved in an aqueous liquid. Suitable borate releasing compounds include, but are not limited to, boric acid, disodium octaborate tetrahydrate, sodium diborate, ulexite, and colemanite. An example of a suitable borate releasing compound is commercially available under the trade name “HMP™ Link” crosslinker from Halliburton Energy Services, Duncan, Okla. Another example of a suitable borate releasing compound is commercially available under the trade name “CL-38™” delayed borate crosslinker from Halliburton Energy Services, Duncan, Okla. Suitable compounds that release transition metal ions, include, but are not limited to, compounds capable of supplying zirconium ions such as, for example, zirconium lactate, zirconium lactate triethanolamine, zirconium carbonate, zirconium acetylacetonate, and zirconium diisopropylamine lactate; compounds capable of supplying titanium ions such as, for example, titanium ammonium lactate, titanium triethanolamine, titanium acetylacetonate; aluminum compounds such as, for example, aluminum lactate or aluminum citrate; compounds capable of supplying iron ions, such as, for example, ferric chloride; compounds capable of supplying chromium ion such as, for example, chromium III citrate; or compounds capable of supplying antimony ions. Generally, the crosslinking agent, in some embodiments, may be added to the aqueous base fluid comprising nonionic cellulose ether polymer in an amount sufficient, inter alia, to provide the desired degree of crosslinking. One of ordinary skill in the art, with the benefit of this disclosure, should be able to determine the appropriate amount and type of crosslinking agent to include for a particular application.

The drilling, completion, or workover fluids optionally may comprise a pH buffer. The pH buffer may be included in the drilling, completion, or workover fluids to maintain pH in a desired range, inter alia, to enhance the stability of the drilling, completion, or workover fluid. Examples of suitable pH buffers include, but are not limited to, sodium carbonate, potassium carbonate, sodium bicarbonate, potassium bicarbonate, sodium or potassium diacetate, sodium or potassium phosphate, sodium or potassium hydrogen phosphate, sodium or potassium dihydrogen phosphate, sodium borate, sodium or ammonium diacetate, sulfamic acid, and the like. The pH buffer may be present in a drilling, completion, or workover fluid in an amount sufficient to maintain the pH of the drilling, completion, or workover fluid at a desired level. One of ordinary skill in the art, with the benefit of this disclosure, will recognize the appropriate pH buffer and amount of pH buffer to use for a chosen application.

Optionally, the drilling, completion, or workover fluids further may include pH-adjusting compounds for adjusting the pH of the drilling, completion, or workover fluid, inter alia, to a desired pH for crosslinking and/or enhance hydration of the nonionic cellulose ether polymer. Suitable pH-adjusting compounds include any pH-adjusting compound that does not adversely react with the other components of the drilling, completion, or workover fluid. Examples of suitable pH-adjusting compounds include, but are not limited to, sodium hydroxide, potassium hydroxide, lithium hydroxide, sodium carbonate, potassium carbonate, fumaric acid, formic acid, acetic acid, acetic anhydride, hydrochloric acid, hydrofluoric acid, hydroxyfluoboric acid, polyaspartic acid, polysuccinimide, ammonium diacetate, sodium diacetate, and sulfamic acid. The appropriate pH-adjusting compound and amount thereof may depend upon the formation characteristics and conditions, and other factors known to individuals skilled in the art with the benefit of this disclosure. For example, where a borate-releasing compound is utilized as the crosslinking agent, the pH of the drilling, completion, or workover fluids should be adjusted to above about 8 to about 12 to facilitate the crosslink of the nonionic cellulose ether polymer. Those skilled in the art, with the benefit of this disclosure, will be able to adjust the pH range in the viscosified aqueous fluids as desired.

In some applications, after the drilling, completion, or workover fluid has performed its desired function, its viscosity may be reduced. For example, in subterranean treatments and operations, once the viscosity is reduced, the drilling, completion, or workover fluid may be flowed back to the surface, and the well may be returned to production. The viscosity of the drilling, completion, or workover fluids may be reduced by a variety of means. In some embodiments, breakers capable of reducing the viscosity of the drilling, completion, or workover fluids at a desired time may be included in the drilling, completion, or workover fluid to reduce the viscosity thereof. In other embodiments, delinkers capable of lowering the pH of the drilling, completion, or workover fluids at a desired time may be included in the drilling, completion, or workover fluid to reduce the viscosity thereof. Such delinkers may be especially useful when the nonionic cellulose ether polymer has been crosslinked with a metal ion.

In some embodiments, the drilling, completion, or workover fluids further may comprise a breaker. Any breaker that is able to reduce the viscosity of the drilling, completion, or workover fluids when desired is suitable for use in the methods of the present invention. In certain embodiments, delayed gel breakers that will react with the drilling, completion, or workover fluids after desired delay periods may be used. Suitable delayed gel breakers may be materials that are slowly soluble in a drilling, completion, or workover fluid. Examples of suitable delayed breakers include, but are not limited to, enzyme breakers, such as alpha and beta amylases, amyloglucosidase, invertase, maltase, cellulase, and hemicellulase; acids, such as maleic acid and oxalic acid; and oxidizing agents, such as sodium chlorite, sodium bromate, sodium persulfate, ammonium persulfate, magnesium peroxide, lactose, ammonium sulfate, and triethanol amine. An example of a suitable delayed gel breaker is commercially available under the trade name “VICON NF™” breaker from Halliburton Energy Services, Duncan, Okla. In some embodiments, these delayed breakers can be encapsulated with slowly water-soluble or other suitable encapsulating materials. Examples of water-soluble and other similar encapsulating materials that may be suitable include, but are not limited to, porous solid materials such as precipitated silica, elastomers, polyvinylidene chloride (PVDC), nylon, waxes, polyurethanes, polyesters, cross-linked partially hydrolyzed acrylics, other polymeric materials, and the like. The appropriate breaker and amount thereof may depend upon the formation characteristics and conditions, the pH of the drilling, completion, or workover fluid, and other factors known to individuals skilled in the art with the benefit of this disclosure. In some embodiments, the breaker may be included in a drilling, completion, or workover fluid in an amount in the range of from about 0.1 gallons to about 100 gallons per 1000 gallons of the aqueous base fluid. Such breakers may be especially useful when the nonionic cellulose ether polymer has been crosslinked with a metal ion.

In the crosslinked embodiments, the drilling, completion, or workover fluids may comprise a delinker that is capable of lowering the pH of the drilling, completion, or workover fluid at a desired time causing the crosslinks of the viscosifying agent to reverse. For example, when certain crosslinking agents, such as borate-releasing compounds, are used, the crosslinks may be reversed (or delinked) by lowering the pH of the drilling, completion, or workover fluid to below about 8. The delinker may comprise encapsulated pH-adjusting agents or acid-releasing degradable materials capable of reacting over time in an aqueous environment to produce an acid. In certain embodiments, suitable pH-adjusting agents include, but are not limited to, fumaric acid, formic acid, acetic acid, acetic anhydride, hydrochloric acid, hydrofluoric acid, hydroxyfluoboric acid, polyaspartic acid, polysuccinimide, combinations thereof, and the like. In these embodiments, the pH-adjusting agents may be encapsulated using any suitable encapsulation technique. Exemplary encapsulation methodology is described in U.S. Pat. Nos. 5,373,901; 6,444,316; 6,527,051; and 6,554,071, the relevant disclosures of which are incorporated herein by reference. Acid-releasing degradable materials also may be included in the drilling, completion, or workover fluids to decrease the pH of the drilling, completion, or workover fluid. Suitable acid-releasing degradable materials that may be used in conjunction with the present invention are those materials that are substantially water insoluble such that they degrade over time, rather than instantaneously, in an aqueous environment to produce an acid. Examples of suitable acid-releasing degradable materials include orthoesters; poly(ortho esters); lactides; poly(lactides); glycolides; poly(glycolides); substituted lactides wherein the substituted group comprises hydrogen, alkyl, aryl, alkylaryl, acetyl heteroatoms and mixtures thereof; substantially water insoluble anhydrides; and poly(anhydrides). Depending on the timing required for the reduction of viscosity, the acid-releasing degradable material may provide a relatively fast break or a relatively slow break, depending on, for example, the particular acid-releasing degradable material chosen. Materials suitable for use as an acid-releasing degradable material may be considered degradable if the degradation is due, inter alia, to chemical and/or radical processes, such as hydrolysis, oxidation, or enzymatic decomposition. The inclusion of a particular delinker and amount thereof may depend upon the formation characteristics and conditions, the particular crosslinking agent, and other factors known to individuals skilled in the art with the benefit of this disclosure. In some embodiments, the delinker may be included in a drilling, completion, or workover fluid in an amount in the range of from about 0.01 pounds to about 100 pounds per 1000 gallons of the single salt aqueous fluid.

The drilling, completion, or workover fluids optionally may comprise a catalyst. The use of a catalyst is optional, but a catalyst may be included in the drilling, completion, or workover fluids to activate the breaker dependent, inter alia, upon the pH of the drilling, completion, or workover fluid and formation conditions. Examples of suitable catalysts include, but are not limited to, transition metal catalysts, such as copper and cobalt acetate. An example of a suitable cobalt acetate catalyst is available under the trade name “CAT-OS-1” catalyst from Halliburton Energy Services, Duncan, Okla. In some embodiments, the catalyst may be included in a drilling, completion, or workover fluid in an amount in the range of from about 0.01 pounds to about 50 pounds per 1000 gallons of the single salt aqueous fluid.

The drilling, completion, or workover fluids may be prepared by any suitable method. In some embodiments, the drilling, completion, or workover fluids may be produced at the well site. As an example, of such an on-site method, nonionic cellulose ether polymer may be combined with an aqueous base fluid. Furthermore, additional additives, as discussed above may be combined with the aqueous base fluid as desired. To form a drilling, completion, or workover fluid, a crosslinking agent, as discussed above, may be added to the aqueous base fluid that comprises the nonionic cellulose ether polymer and other suitable additives.

In other embodiments, a drilling, completion, or workover fluid concentrate may be prepared by combining an aqueous fluid (e.g., water) and a nonionic cellulose ether polymer described herein. Generally, the water in the drilling, completion, or workover fluid concentrate may be fresh water or water containing a relatively small amount of a dissolved salt or salts. The nonionic cellulose ether polymer may be present in the drilling, completion, or workover fluid concentrate in an amount in the range of from about 40 lbs to about 200 lbs per 1000 gallons of the aqueous fluid. In some embodiments, the nonionic cellulose ether polymer may be crosslinked with a metal ion. Furthermore, additional additives, discussed above, that may be included in the drilling, completion, or workover fluids may be added to the drilling, completion, or workover fluid concentrate as desired. In some embodiments, the drilling, completion, or workover fluid concentrate may be prepared at an offsite manufacturing location and may be stored prior to use. Such methods may be preferred, for example, when these drilling, completion, or workover fluid concentrates are to be used in offshore applications, e.g., because the equipment and storage volumes may be reduced. After preparing the drilling, completion, or workover fluid concentrate, the aqueous base fluid, described above, may be combined with the concentrate. When the concentrate is mixed with the aqueous base fluid, no hydration time may be required because the nonionic cellulose ether polymer may already be substantially fully hydrated. Furthermore, the additional additives, discussed above, may be combined with the aqueous base fluid as desired. To form the drilling, completion, or workover fluid, a crosslinking agent, as discussed above, may be added to the aqueous base fluid that comprises the nonionic cellulose ether polymer and other suitable additives.

In accordance with embodiments of the present invention, the drilling, completion, or workover fluids that comprise nonionic cellulose ether polymer may be used in any of a variety of suitable applications. By way of example, the drilling, completion, or workover fluids may be used in subterranean operations, including, but not limited to, underbalanced drilling, overbalanced drilling, completion, and workover operations. Among other things, the drilling, completion, or workover fluids may be used in subterranean operations as drilling fluid additives, and the like.

An example method of the present invention generally may comprise providing a drilling, completion, or workover fluid comprising an aqueous base fluid and a nonionic cellulose ether polymer; and introducing the drilling, completion, or workover fluid into the subterranean formation having a bottom hole temperature of about 275° F. or more or a pressure of 5000 psi or more.

In certain embodiments, the method further may comprise allowing the nonionic cellulose ether polymer to maintain thermal stability and gel strength at temperatures up to about 350° F. The length of time for which thermal stability can be maintained will vary with temperature. For example, at the higher temperatures the gel may degrade at a faster rate.

In certain embodiments, the drilling, completion, or workover fluid may undergo acid hydrolysis of the nonionic cellulose ether polymer. The ability to acid hydrolyze such drilling, completion, or workover fluids may be advantageous in numerous subterranean operations, such as to facilitate a reduction in viscosity of a fluid or to degrade a filter cake.

In some embodiments, the present invention provides methods that include a method comprising: providing a drilling fluid, completion fluid, or workover fluid comprising an aqueous base fluid and a nonionic cellulose ether polymer having hydroxyethyl groups and being further substituted with one or more hydrophobic substituents, wherein the cellulose ether has at least one of the properties (a), (b) or (c): (a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution; (b) a storage modulus of at least 15 Pascals at 25° C. and a retained storage modulus, % G′_{80/25}, of at least 12 percent, wherein % G′_{80/25}=[storage modulus at 80 ° C./storage modulus at 25° C.]×100, the storage modulus at 25° C. and 80° C. being measured as a 1% aqueous solution; (c) a critical association concentration of less than 15 ppm as measured by light-scattering, and placing the drilling fluid, completion fluid, or workover fluid in a subterranean formation.

In some embodiments of the present invention, a drilling fluid that comprises a nonionic cellulose ether polymer as described herein, may be circulated in a well bore while drilling. In certain embodiments, the method may include forming a filter cake comprising the solid particle upon a surface. Fluid loss to the formation through the filter cake may be reduced. As the filter cake comprises the nonionic cellulose ether polymer, the filter cake may be easily removed in accordance with embodiments of the present invention, in that the filter cake may be removed by acid degradation. Though the filter cake formed by the drilling, completion, or workover fluids in accordance with embodiments of the present invention may be easily removed by using an acidic solution, an operator nevertheless occasionally may elect to circulate a separate clean-up solution or breaker through the well bore under certain circumstances, to enhance the rate of degradation of the filter cake. By way of example, removal of the filter cake may be enhanced by contacting the filter cake with water.

An example of a method of the present invention comprises: placing a drill-in fluid in a subterranean formation, the drill-in fluid comprising an aqueous base fluid and a nonionic cellulose ether polymer; and forming a filter cake comprising the nonionic cellulose ether polymer upon the surface within the formation whereby fluid loss through the filter cake is reduced.

In other embodiments, the drilling, completion, or workover fluids may be placed into the well bore as a pill in drilling, completion, or workover operations.

In another embodiment of the present invention, the drilling, completion, or workover fluids may be placed into the subterranean formation as a viscosified pill during an underbalanced drilling operation. An underbalanced drilling operation may be referred to as a managed pressure drilling operation by some skilled in the art. Influxes from the formation may be experienced during an underbalanced drilling operation. Nitrogen may be used to combat this. The drilling, completion, or workover fluids may be recovered by pumping gas into the formation to lift the pill out of the subterranean formation. The treatment fluid is then replaced with drilling fluid.

Another example of a method of the present invention comprises using the drilling, completion, or workover fluids prior to a cementing operation, for example, as a completion fluid. An example of such method may comprise a pre-treatment providing the drilling, completion, or workover fluid comprising an aqueous base fluid and a nonionic cellulose ether polymer; introducing these fluids into the subterranean formation before placing a cement composition into the formation.

In alternative embodiments, the present invention provides drilling, completion, or workover fluids that comprise a nonionic cellulose ether polymer that has been crosslinked with a metal ion. Such drilling, completion, or workover fluids may be useful in a variety of subterranean applications, including, drilling, completion, or workover.

To facilitate a better understanding of the present invention, the following examples of certain embodiments are given. In no way should the following examples be read to limit, or define, the scope of the invention. Representative examples are shown below.

### EXAMPLES

The following series of tests were performed to determine the effect of a hydrophobic modification on a fluid viscosified with a nonionic cellulose ether polymer. The properties of the nonionic cellulose ether polymer were compared to those of conventional viscosifying agents, such as xanthan gum, scleroglucan gum, diutan gum, and unmodified hydroxyethylcellulose. To prepare viscous fluids, samples were prepared by mixing the aqueous base fluid with the polymers. The aqueous media of choice (either brine or freshwater) was added and placed on the paddle mixer at 550 rpms. The polymer samples were then weighed (1 wt %, 7 g) was slowly added to prevent the formation of local viscosified agglomerates. The solutions were allowed to agitate for 90 min for complete and homogeneous mixing.

Rheological studies of each fluid sample were performed and evaluated by a series of tests on the Anton Paar Series 501 and Fann 50 rheometers. Experiments involving shear and temperature sweeps as well as dynamic rheological studies enabled a thorough screening of the nonionic cellulose ether polymer in comparison to various biopolymers. The drilling, completion, or workover fluids comprising the various polymers and their performance in freshwater and various monovalent and divalent brines was described.

### Example 1

Brine testing was performed to determine the solubility of the nonionic cellulose ether polymer. The following brines were tested: 10.0 ppg NaBr; 10.0 ppg NaCl; 10.0 ppg CaCl₂ brines were tested for performance before and after hot roll for the various certain polymers remain insoluble in these fluid.

The solubility of the nonionic cellulose ether polymeric material was evaluated in the numerous aqueous media listed above. Following the mixing procedure detailed earlier, the HMHEC samples exhibited excellent solubility and viscosity response after 90 min. However, the concentrated NaCl (10.0 ppg) proved to be the only brine in which the HMHEC did not yield the desired properties. We can attribute this to the minimization of free water within the saturated brine as well as the possible “salting out” effects of the Na⁺ and Cl⁻ ions on the C₁₆ alkyl modifications located on the hydrophobically modified polymer rendering it solubility or “dispersibility” limited as the polymer adopts a very collapsed conformation. Also, in the case of the 13.5 ppg CaBr₂ and 15.5 ppg Ca/ZnBr₂, a concentrated HMHEC glycol mixture was employed to deliver the polymer into these brines to decrease the hydration time. The HMHEC did yield in these particular brines in the dry form, but it was much slower and needed the application of heat to achieve the proper enthalpy of mixing. After the mixing was complete, the samples were allowed to age at 150° F. for 4 hours to ensure polymer relaxation before the rheological tests were completed. The data for the shear rate sweeps at 77° F. (25° C.) for each solution is provided below (with the exception of 10.0 ppg NaCl).

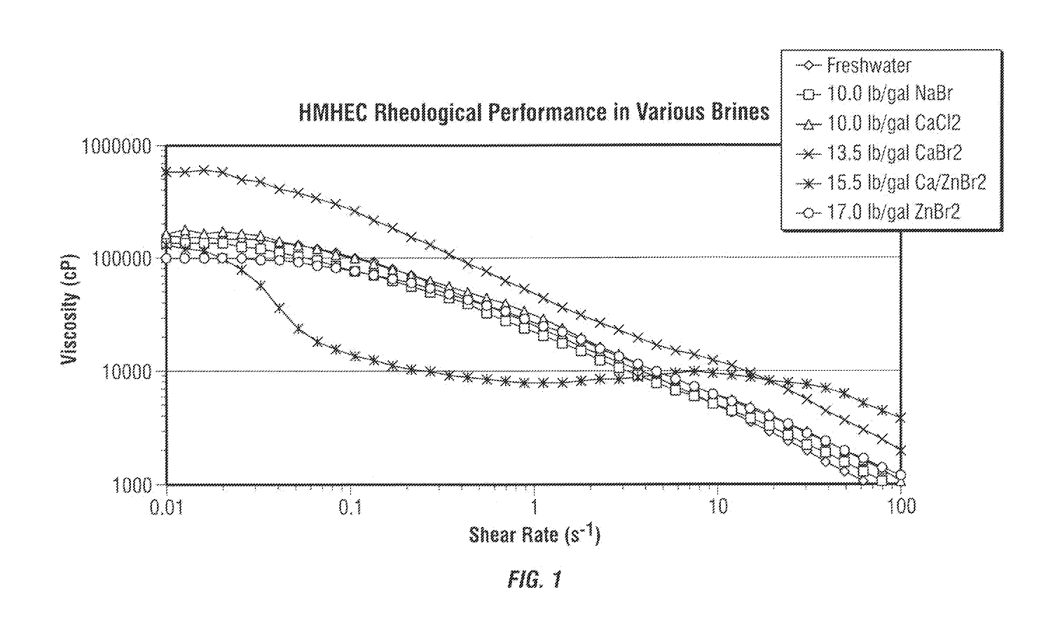

FIG. 1 depicts the rheological performance in various brines at 1 wt % polymer, It can be seen that the nonionic cellulose ether polymer provides excellent low shear viscosity response that thins off at high shear rates (i.e., thixotropic flow properties). It should be noted that the 15.5 ppg Ca/ZnBr₂ sample was actually gelled to the extent that it was not possible to achieve the correct reading due to the Weissenberg effect within the Anton Paar geometry. However, the indication of such elevated low shear viscosities was evidence of possible increased suspension capabilities versus traditional unmodified hydroxyethylcellulose.

A comparative analysis of other biopolymers was also performed, by comparing the properties of each biopolymer in each brine mentioned above by monitoring the capabilities of the nonionic cellulose ether polymer as to its rheological behavior (i.e., flow and suspension properties) and thermal stability.

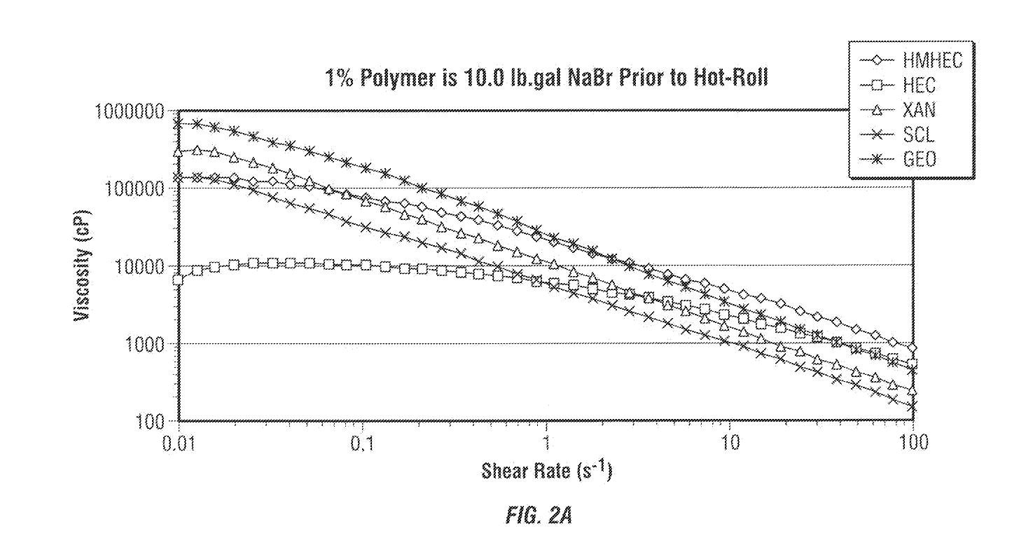

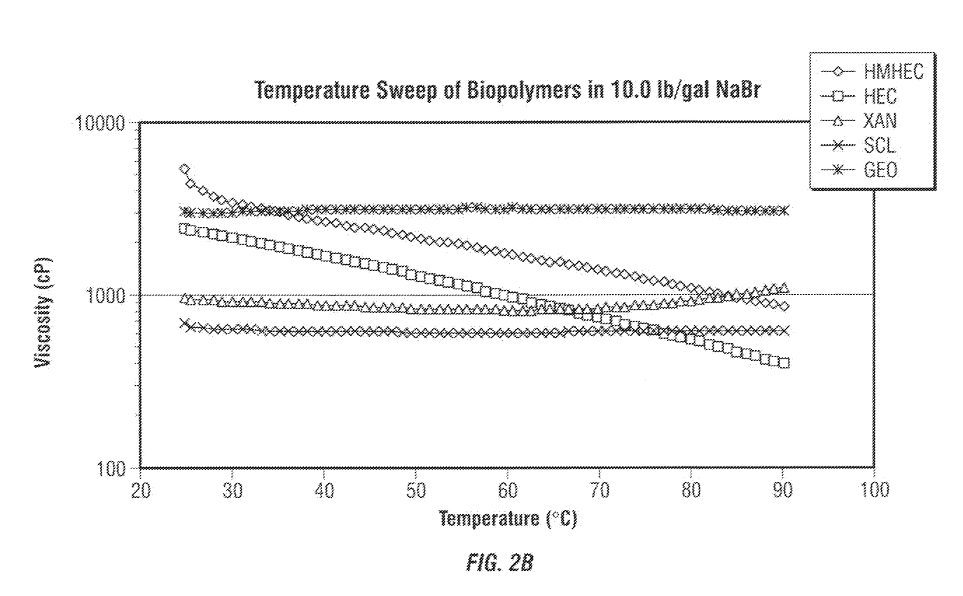

FIGS. 2A-B depict the comparative study of the various biopolymers in 10.0 ppg NaBr. All the chosen biopolymers were mixed as described above and allowed to equilibrate at 150° F. for 4 h before testing. The low shear viscosity of the nonionic cellulose ether polymer is comparable to the other biopolymers (particularly Xanthan) that are known to provide excellent suspension characteristics. When compared to unmodified hydroxyethylcellulose, the hydrophobically modified polymer exhibits low shear viscosity values that are an order of magnitude higher (10×). The experimental nonionic cellulose ether polymer does not thermally thin to the extent of unmodified hydroxyethylcellulose and provides viscosity comparable to Xanthan at 190° F. It should be pointed out that the Diutan and Scleroglucan gums do not thermally thin to any extent within the tested temperature parameters as expected from their physicochemical properties.

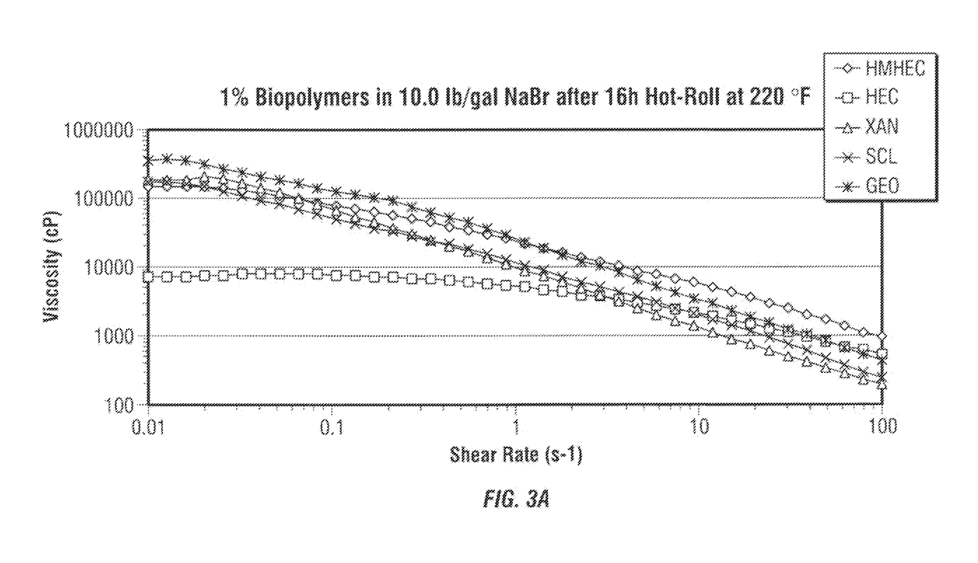

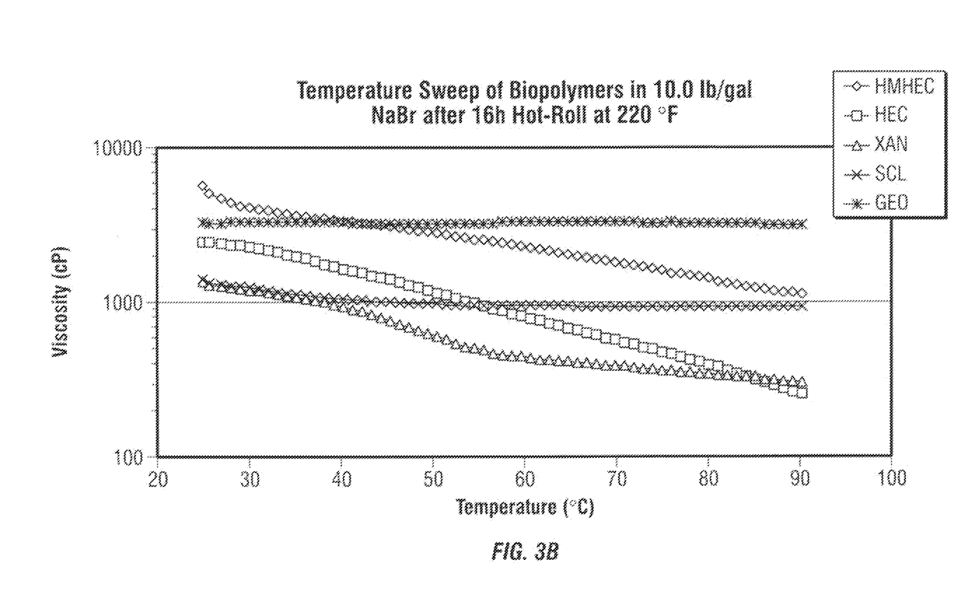

At the completion of the first set of examinations, the samples were allowed to static age at 220° F. for 16 h inside glass jars placed located in stainless steel aging cells. The samples were then cooled and allowed to mix at 500 rpm for 10 min. The same test sequences were then repeated. FIGS. 3A-B show the nonionic cellulose ether polymer exhibits excellent thermal stability in the NaBr solution and negligible thermal degradation was observed. When compared to Xanthan, the nonionic cellulose ether polymer shows improved performance post static aging as then Xanthan demonstrates dramatic thermal thinning and decreased gelation behavior.

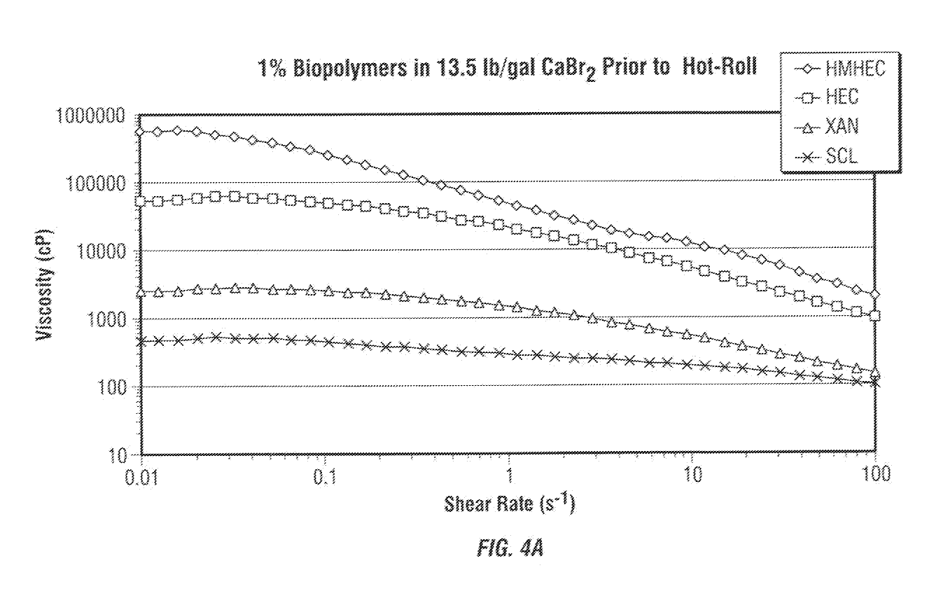

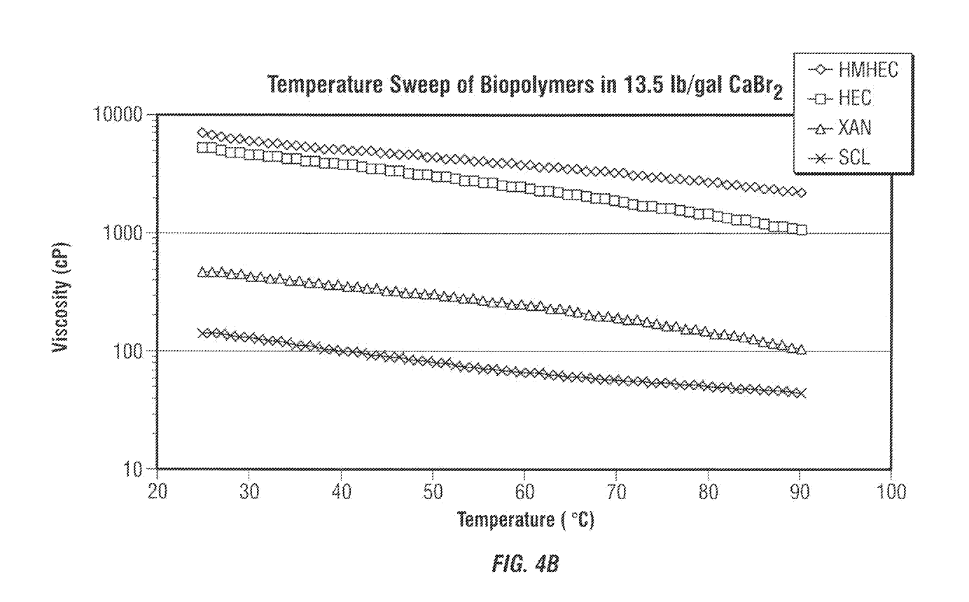

FIGS. 4A-B depict the comparative study of the various biopolymers in 13.5 ppg CaBr₂. The employment of divalent brines proved to be quite interesting. The solubility of the various biopolymers in the 13.5 ppg CaBr₂ was limited as the Scleroglucan yielded only minimal viscosity response and Diutan would not disperse to any extent. However, the nonionic cellulose ether polymer proved to be an excellent choice as it performed with superb rheological properties and nominal thermal thinning. The nonionic cellulose ether polymer maintained its thixotropic nature as well as elevated low shear viscosity values. Once again, these rheological characteristics are indicative of increased suspension properties when compared to traditional unmodified hydroxyethylcellulose and are a result of the hydrophobic associations due to the hydrophobic modifications.

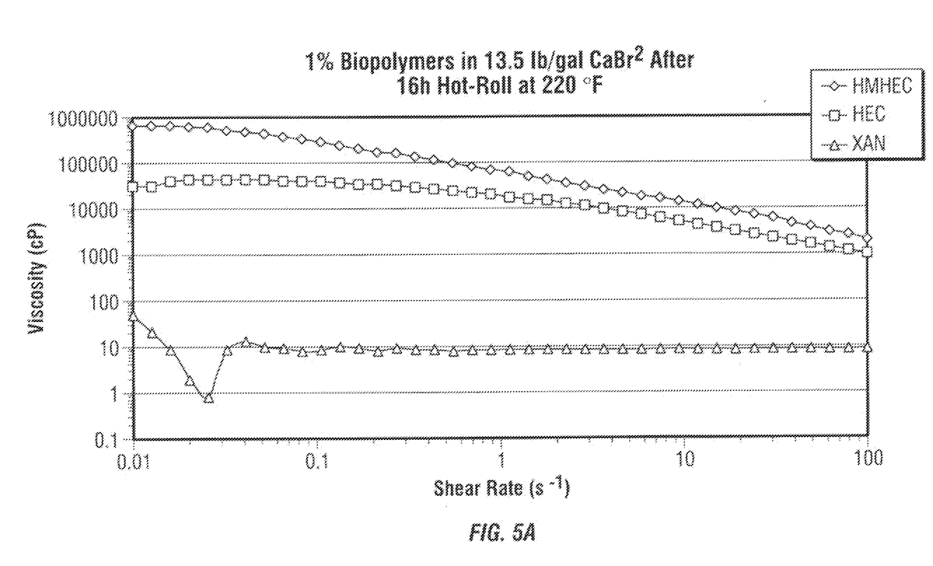

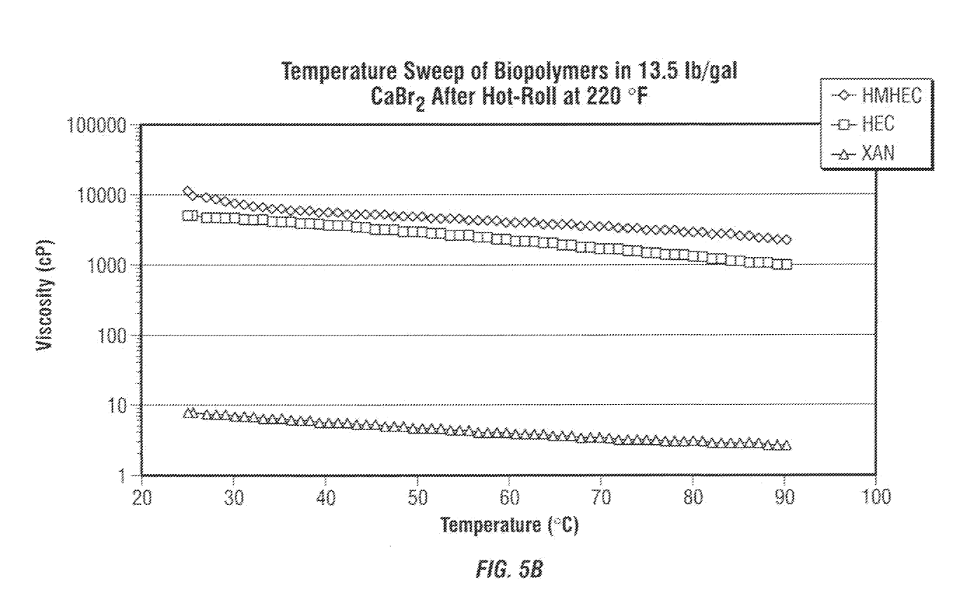

The CaBr₂ samples were also static-aged at 220° F. for 16 h, as seen in FIGS. 5A-B. The divalent brine managed to drive the Scleroglucan gum out of solution as the polymeric mixture phase separated due to decreased solubility parameters resulting in a collapsed conformation of the polymer structures. By contrast, the nonionic cellulose ether polymer continued with exemplary performance after the static aging whereas Xanthan began to fail at the elevated temperatures.

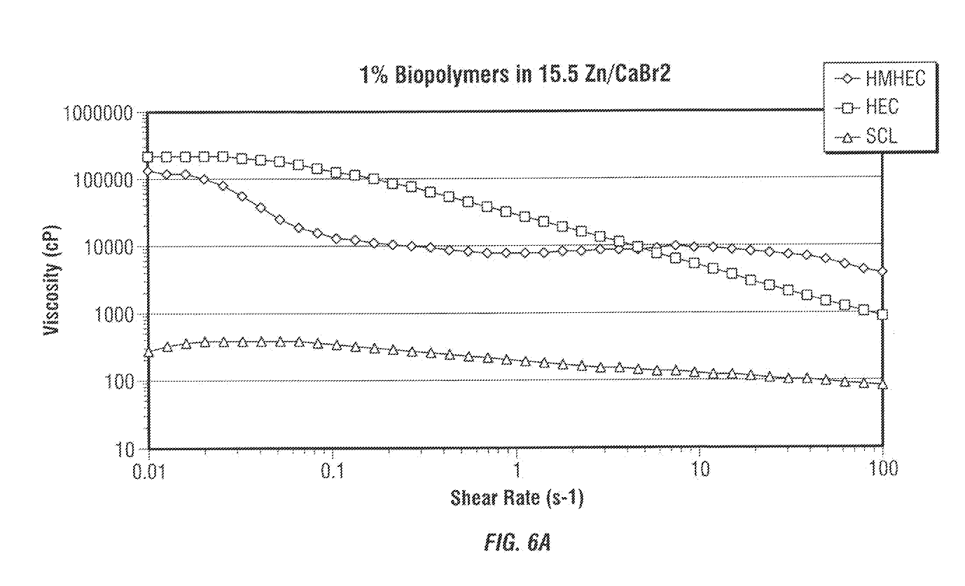

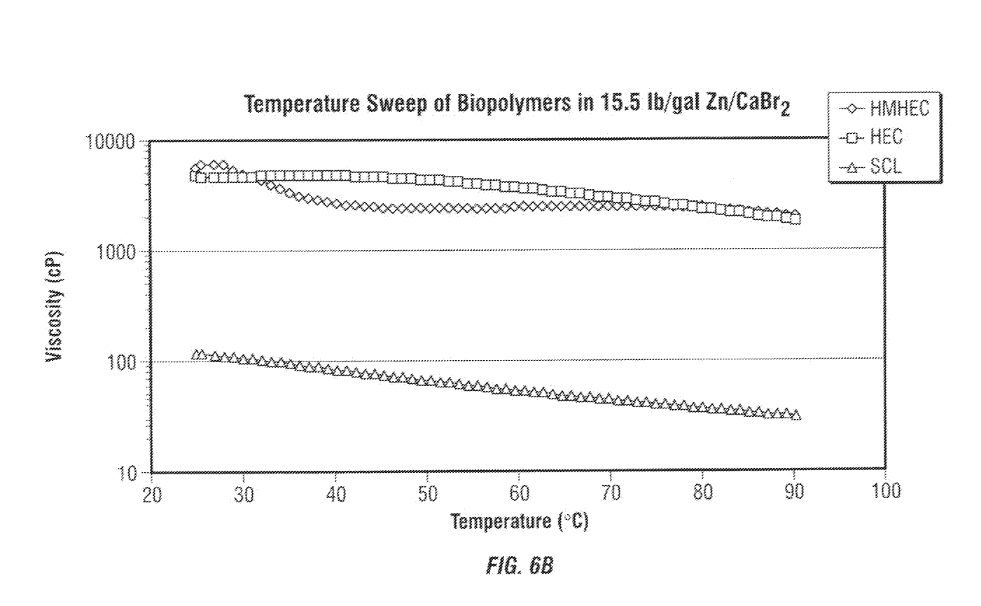

FIGS. 6A-B depict the comparative study of the various biopolymers in 15.5 ppg Ca/ZnBr₂. Nonionic cellulose ether polymer provided an excellent viscosity response when blended with the 15.5 ppg Ca/ZnBr₂ salt solution. Such an increase in viscosity was observed that while performing the rheological studies, the fluid exhibited the Weissenberg effect thus rendering the sample difficult to measure with the chosen geometry for the polymer solution studies. HEC also rendered excellent viscosity profiles but, in the case of both polymers, most of the response was manifested in the viscous component (i.e., loss modulus). This behavior is seen when the polymers are not displaying any intermolecular associations other than simple chain entanglement thus leading to the reduction of suspension capabilities and thixotropic behavior. In the case of the Diutan and Xanthan, neither biopolymer was able to provide sufficient yield needed for evaluation.

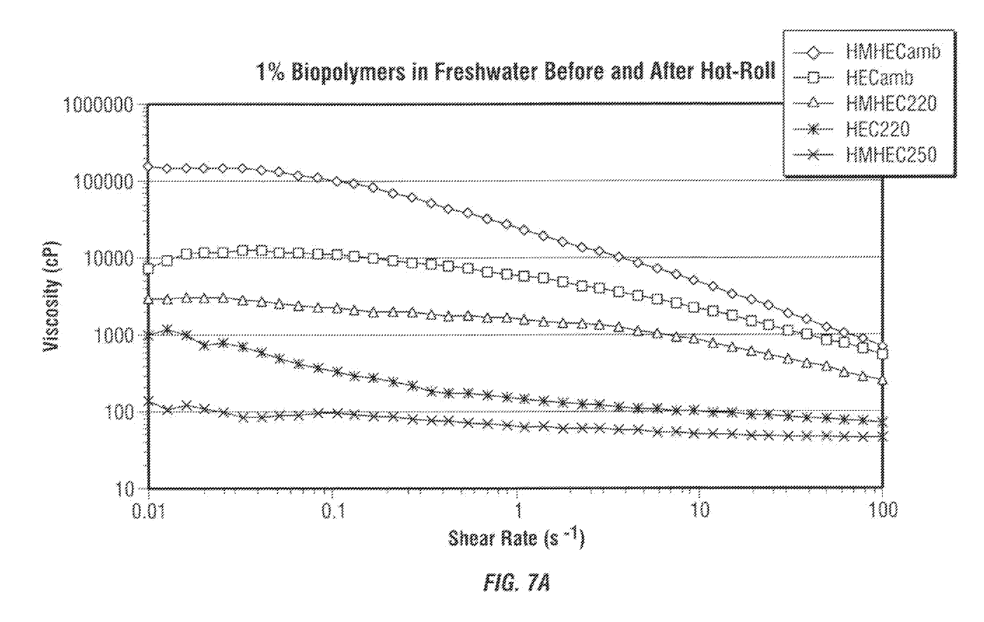

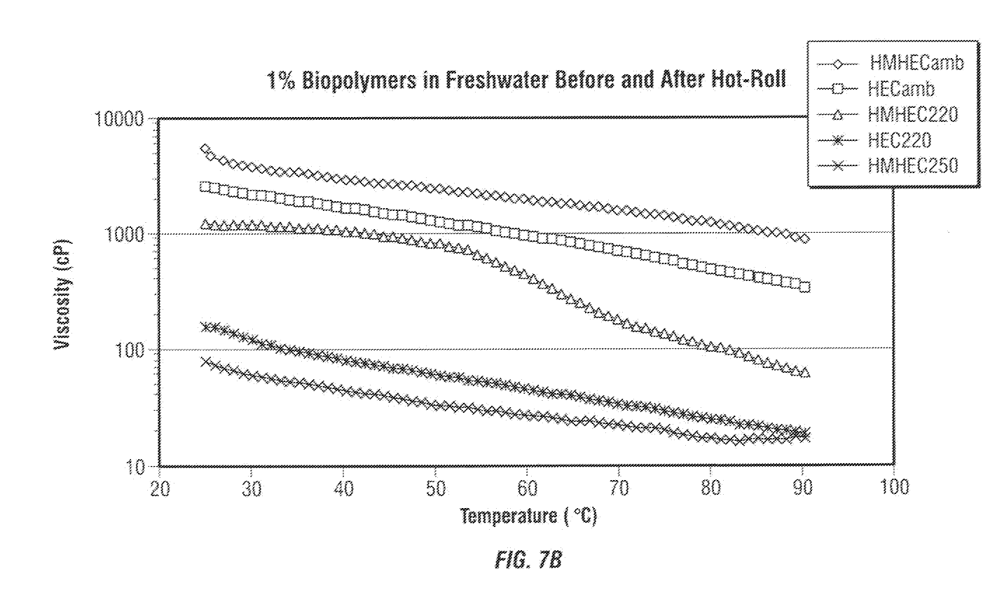

In addition to the brine examinations, we also monitored the performance in the presence of freshwater as a means of observing its thermal stability. In the case of the deionized solutions, only nonionic cellulose ether polymer and hydroxyethylcellulose were compared. FIGS. 7A-B show the ambient temperature profiles were as expected with the nonionic cellulose ether polymer providing superb gelation behavior as well as shear thinning properties. At 220° F., both the unmodified hydroxyethylcellulose and nonionic cellulose ether polymer showed drastic losses in viscosity after the 16 h static aging although the nonionic cellulose ether polymer still had slightly better performance. At 250° F., the hydroxyethylcellulose lost all viscosity as the polymer underwent extensive hydrolysis while the nonionic cellulose ether polymer maintained a reasonable some viscosity. It was observed that the thermal stability of the nonionic cellulose ether polymer was enhanced when utilized within brine. Such behavior was indicative of increased rates of hydrolysis with increased amounts of free water existing within the freshwater system as compared to brines.

### Example 2

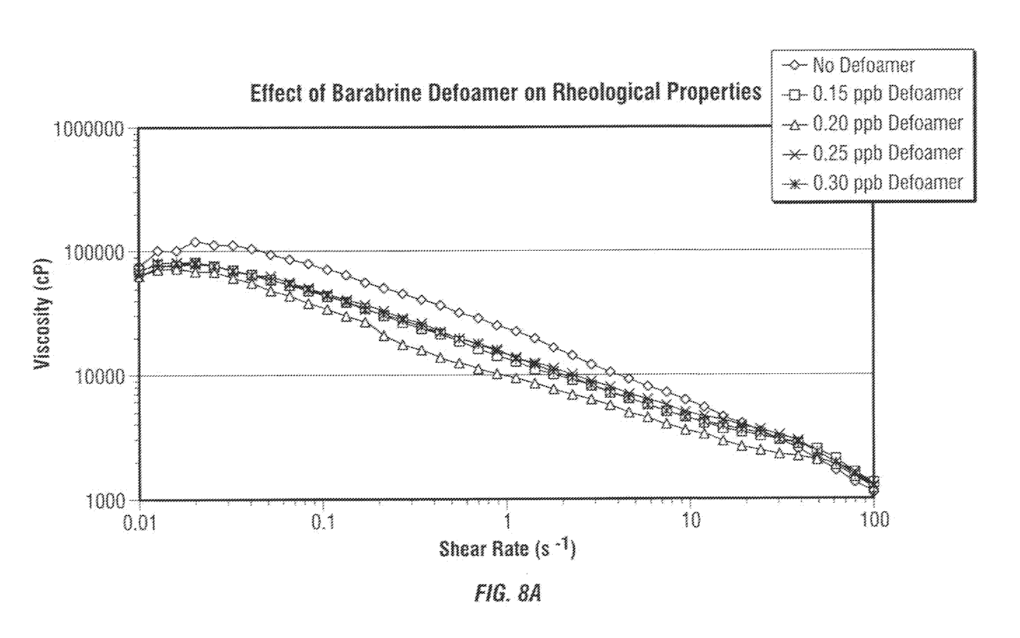

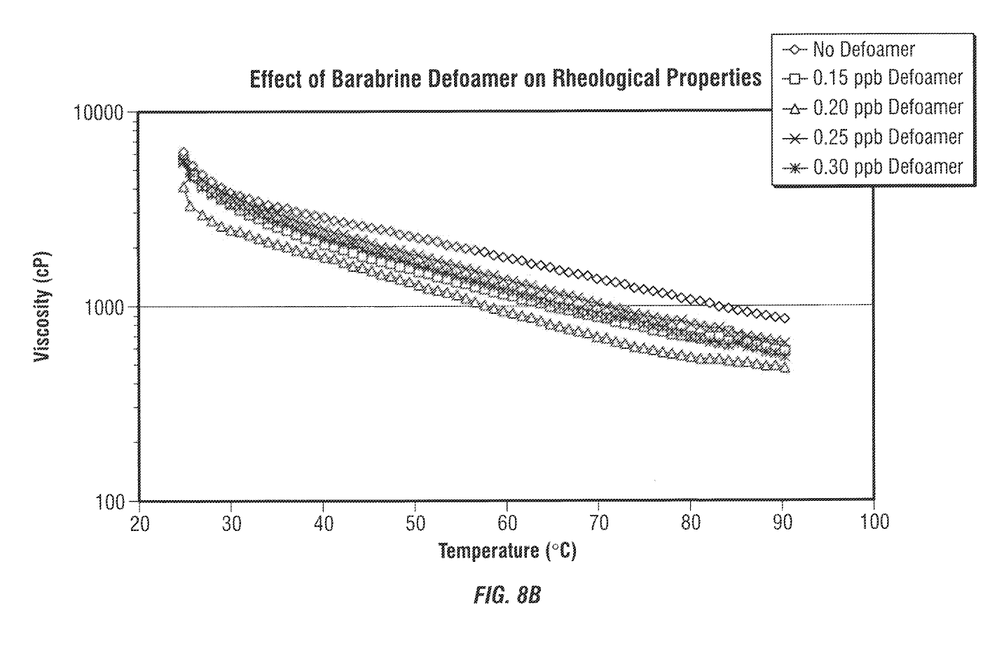

The effect of a defoamer (i.e., BARABRINE defoamer) was measured to assess the contamination stability (effect of defoamer, glycols, etc.) of the nonionic cellulose ether polymer in the drilling, completion, or workover fluids. The breakdown of the hydrophobically modified hydroxyethylcellulose in the drilling, completion, or workover fluids via acid hydrolysis or oxidation was also measured. BARABRINE Defoamer was the defoaming agent of choice for the examinations. The components were placed in the aqueous media before the polymers were added to monitor the effect of the defoamer on the polymers solubility as well as the associative performance that provides the gelation behavior of the nonionic cellulose ether polymer system. FIGS. 8A-B depict that the addition of defoamer had negligible consequence on the solubility of the nonionic cellulose ether polymer. The polymers showed excellent yield and viscosity response with the BARABRINE defoamer included, but there was a slight decrease when compared to the profile provided by the control sample. However, the utilization of the defoamer was not a detriment to the performance of the nonionic cellulose ether polymer.

### Example 3

As seen in the previous sections, the nonionic cellulose ether polymer seemed to provide gelation behavior that was similar to that of Xanthan. The ability of the new biopolymer to provide suspension characteristics would be a vast improvement over the capabilities of conventional hydroxyethylcellulose. In order to investigate this type of behavior, dynamic rheological studies were performed via the Anton Paar rheometer to evaluate the storage (G′) and loss (G″) moduli of nonionic cellulose ether polymer versus Xanthan and hydroxyethylcellulose. Xanthan and hydroxyethylcellulose were excellent representatives as both are known to display both ends of the spectrum as Xanthan has gelation behavior and hydroxyethylcellulose does not.

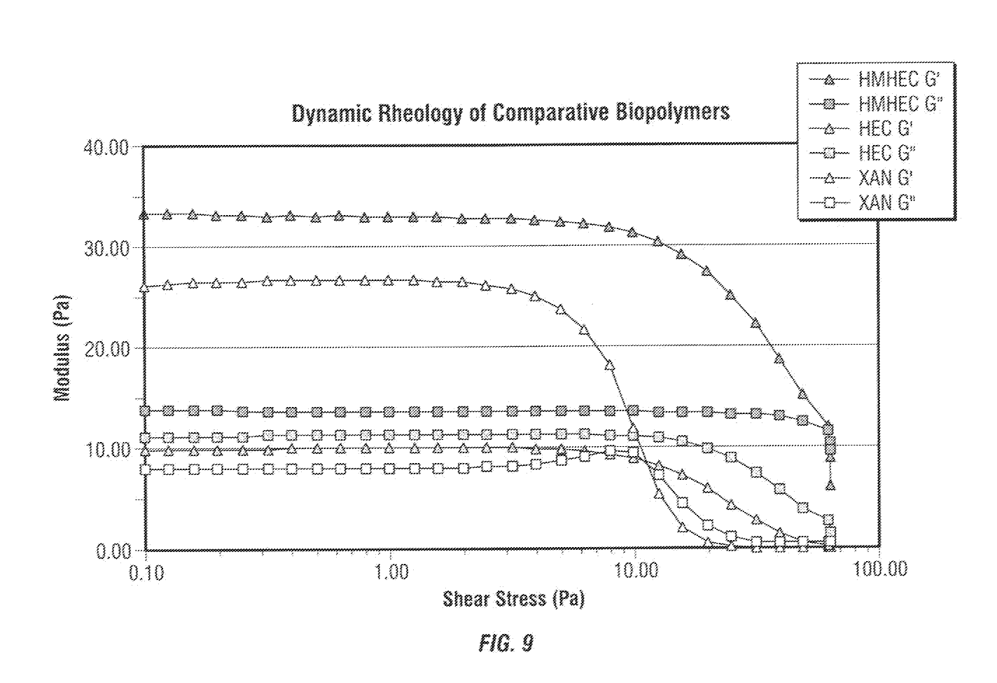

The polymer samples were mixed in 10.0 ppg NaBr at 1 wt % polymer additive. FIG. 9 depicts that unmodified hydroxyethylcellulose exhibited a loss modulus (G″) greater than the storage modulus (G′). The rheological response had a significant viscous component but minimal elastic component which was indicative of a polymer network that does not yield favorable gel strengths and suspension properties. Xanthan displayed the opposite behavior than that of unmodified hydroxyethylcellulose. It had a dramatic elastic response thus providing evidence of its ability to produce preferred suspension characteristics up to 10 Pa.

FIG. 9 further shows that nonionic cellulose ether polymer demonstrated behavior that was similar to Xanthan in nature but superior in terms of performance. The storage modulus was more than double the loss modulus.

### Example 4

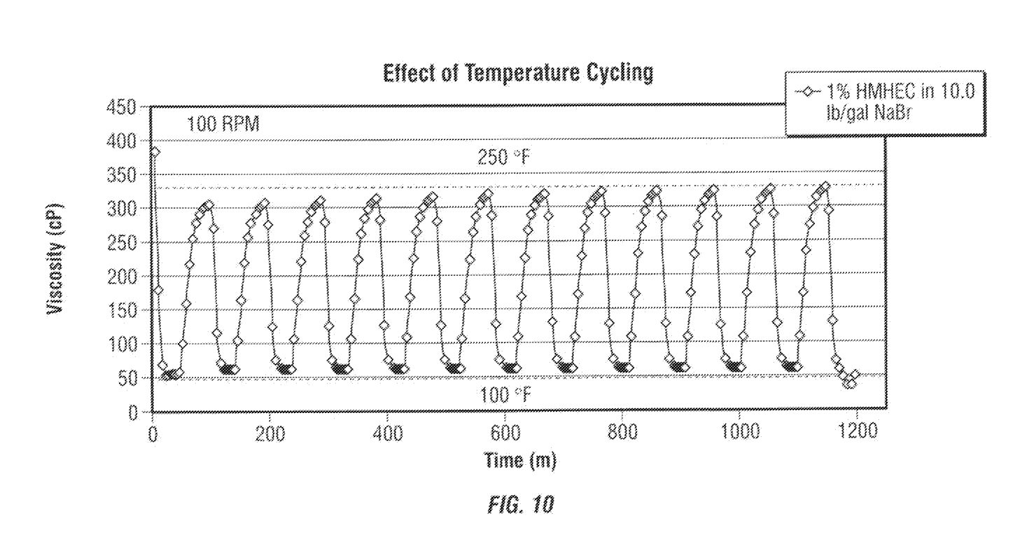

1 wt % solution of nonionic cellulose ether polymer in 10.0 ppg NaBr was also studied on the FANN 50 viscometer to investigate the polymer's thermal stability in a simulated drilling environment. 42 ml of the polymer solution was placed inside the test cell and cycled to 250° F. and held for 30 minutes after which it was cooled to 100° F. and held for ten minutes at a constant shear rate of 100 rpms. The cycle was repeated for 20 h. It can be seen in FIG. 10 that the nonionic cellulose ether polymer maintained its composition and did not diminish in viscosity response during the tested duration of simulated drilling. The thermal stability was markedly improved over what is traditionally observed with unmodified hydroxyethylcellulose.

### Example 5

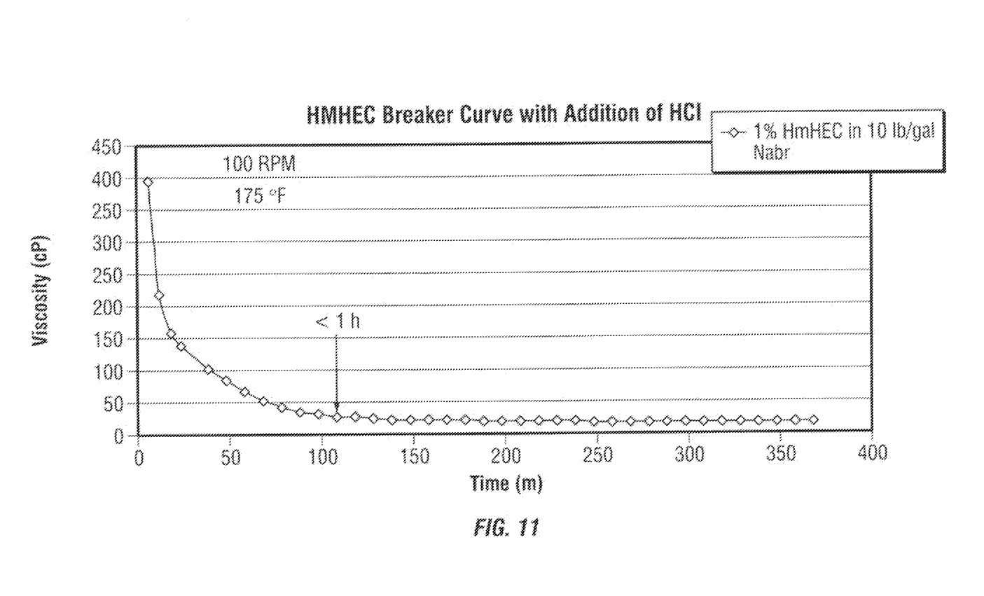

Nonionic cellulose ether polymer was monitored to assay its ability to break down in the presence of acid and heat. The same solution utilized in the previous section (i.e., 1 wt % solution of nonionic cellulose ether polymer in 10.0 ppg NaBr) was treated with 9 M HCl to lower the pH to 3.0. The solution was then placed in the FANN 50 viscometer and heated to 175° F. at 100 rpms. As seen by FIG. 11, in less than 1 h, the viscosity of the solution had dramatically decreased as acid hydrolysis had chemically broken down the polymer.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is:

1. A method comprising:
providing a drilling fluid, completion fluid, or workover fluid comprising an aqueous base fluid and a nonionic cellulose ether polymer having hydroxyethyl groups and being further substituted with one or more hydrophobic substituents, wherein the cellulose ether has at least one of the properties (a), (b) or (c):
(a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution;
(b) a storage modulus of at least 15 Pascals at 25° C. and a retained storage modulus, % G′_{80/25}, of at least 12 percent, wherein % G′_{80/25}=[storage modulus at 80° C./storage modulus at 25° C.]×100, the storage modulus at 25° C. and 80° C. being measured as a 1% aqueous solution;
(c) a critical association concentration of less than 15 ppm as measured by light-scattering, and
placing the drilling fluid, completion fluid, or workover fluid in a subterranean formation.

2. The method of claim 1 wherein placing the drilling fluid, completion fluid, or workover fluid in the subterranean formation is part of a subterranean operation selected from the group consisting of an underbalanced drilling operation, an overbalanced drilling operation, and a completion operation.

3. The method of claim 1 wherein the subterranean formation comprises a bottom hole temperature of up to and including about 275° F.

4. The method of claim 1 wherein the subterranean formation comprises a bottom hole temperature of 200° F. or more and/or a pressure of at least 5,000 psi,

5. The method of claim 1 wherein the aqueous base fluid is selected from the group consisting of fresh water, salt water, brine, seawater, and any combinations thereof.

6. The method of claim 1 wherein the nonionic cellulose ether is present in the drilling fluid, completion fluid, or workover fluid in an amount in the range of about 0.01% to about 15% by weight of the drilling fluid, completion fluid, or workover fluid.

7. The method of claim 1 wherein the nonionic cellulose ether polymer has a molecular weight in the range of from about 500,000 to 10,000,000.

8. The method of claim 1 wherein the drilling fluid, completion fluid, or workover fluid is able to maintain thermal stability and gel strength at temperatures up to about 350° F.

9. The method of claim 1 wherein the nonionic cellulose ether polymer is able to maintain structure in a stress range exceeding about 12 Pa.

10. The method of claim 1 wherein the nonionic cellulose ether polymer is modified by the addition of a hydrocarbon group having from about 1 to about 22 carbon atoms.

11. The method of claim 8 wherein the hydrocarbon group is selected from the group consisting of a linear alkyl, a branched alkyl, an alkenyl, an aryl, an alkylaryl, an arylalkyl, a cycloalkyl, and a mixture thereof.

12. The method of claim 1 wherein the drilling fluid, completion fluid, or workover fluid comprises additional additives selected from the group consisting of a defoamer, a surfactant, a crosslinking agent, a proppant particulate, a gravel particulate, a pH-adjusting agent, a pH buffer, a breaker, a delinker, a catalyst, and combinations thereof.

13. The method of claim 1 wherein the nonionic cellulose ether polymer is crosslinked with a metal ion.

14. A method comprising:
providing a drilling fluid comprising an aqueous base fluid and a nonionic cellulose ether polymer having hydroxyethyl groups and being further substituted with one or more hydrophobic substituents, wherein the cellulose ether has at least one of the properties (a), (b) or (c):
(a) a retained dynamic viscosity, % η_{80/25}, of at least 30 percent, wherein % η_{80/25}=[dynamic solution viscosity at 80° C./dynamic solution viscosity at 25° C.]×100, the dynamic solution viscosity at 25° C. and 80° C. being measured as 1% aqueous solution;
(b) a storage modulus of at least 15 Pascals at 25° C. and a retained storage modulus, % G′_{80/25}, of at least 12%, wherein % G′_{80/25}=[storage modulus at 80° C./storage modulus at 25° C.]×100, the storage modulus at 25° C. and 80° C. being measured as a 1% aqueous solution;
(c) a critical association concentration of less than 15 ppm as measured by light-scattering; and
drilling a well bore in a formation in an operation comprising the drilling fluid.

15. The method of claim 14 wherein the drilling fluid is placed in the subterranean formation as part of a subterranean operation selected from the group consisting of an underbalanced drilling operation, and an overbalanced drilling operation.

16. The method of claim 14 wherein the nonionic cellulose ether polymer is crosslinked with a metal ion,

17. The method of claim 14 wherein the drilling fluid comprises a hydrophobically modified hydroxyethylcellulose in an amount in the range of about 0.01% to about 15% by weight of the drilling fluid.

18. The method of claim 11 wherein the nonionic cellulose ether polymer has a molecular weight in the range of from about 500,000 to 10,000,000.

19. The method of claim 11 wherein the drilling fluid is able to maintain thermal stability and gel strength at temperatures up to about 350° F.

20. The method of claim 11 wherein the nonionic cellulose ether polymer is able to maintain structure in a stress range exceeding about 12 Pa.

21. The method of claim 11 wherein the nonionic cellulose ether polymer is modified by the addition of a hydrocarbon group with from about 1 to about 22 carbon atoms selected from the group consisting of a linear alkyl, a branched alkyl, an alkenyl, an aryl, an alkylaryl, an arylalkyl, a cycloalkyl, and a mixture thereof.
